(19) United States
(12) Patent Application Publication
(10) Pub. No.: US 2020/0298102 A1
(43) Pub. Date: Sep. 24, 2020

(54) INTERACTIVE GAMING TABLE

(71) Applicant: Sonia Varrasso, Gibsonia, PA (US)

(72) Inventor: Sonia Varrasso, Gibsonia, PA (US)

(21) Appl. No.: 16/827,458

(22) Filed: Mar. 23, 2020

Related U.S. Application Data
(60) Provisional application No. 62/821,897, filed on Mar. 21, 2019.

(51) Int. Cl. A63F 13/2145; A63F 13/847; A63F 13/792; A63F 13/795; A63F 13/335

(52) U.S. Cl. CPC A63F 13/2145; A63F 13/847; A63F 13/792; A63F 2300/5546; A63F 13/335; A63F 2300/308; A63F 2300/1075; A63F 13/795

(57) ABSTRACT

An interactive gaming system. The interactive gaming system including a tabletop and a display screen integrated within the tabletop. The interactive gaming system also includes a user interface shown on the display screen. The user interface allows a user to select a game select one or more game options and pay for the game.

### CROSS-REFERENCE TO RELATED APPLICATIONS

This application claims the benefit of and priority to U.S. Provisional Patent Application Ser. No. 62/821,897 filed on Mar. 21, 2019, which application is incorporated herein by reference in its entirety.

### BACKGROUND OF THE INVENTION

Paid gaming systems suffer from a number of drawbacks. For example, they often allow a user to select only a single game. I.e., machines, such as arcade games only have a single game that can be played. This allows for some customization of controllers and hardware, it means that all of the hardware must be purchased each time a game is purchased. Further, this means that considerable space is needed to fit each desired machine.

Some gaming systems take advantage of technology to create virtual controls on a touchscreen or pad or a set number of controllers that allow hardware to be used for a variety of games, but this is not present in paid gaming systems. This is in part because, these systems often suffer from the fact that software must be loaded onto the hardware before it can be played, which means that a user would have to wait for the load time, something that a consumer may be unwilling to do. In addition, these systems don't monitor user play, and so they are rarely installed where people pay for games.

Moreover, these paid gaming systems often limit the number of players that can play with one another both in number and in the fact that the users need to be physically located near one another (normally on the same machine) which limits the ability to play with friends.

Accordingly, there is a need for a gaming system that allows for customization of games while minimizing used space. In addition, there is a need for the gaming system to allow play among multiple users.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes an interactive gaming system. The interactive gaming system including a tabletop and a display screen integrated within the tabletop. The interactive gaming system also includes a user interface shown on the display screen. The user interface allows a user to select a game select one or more game options and pay for the game.

Another example embodiment includes an interactive gaming system. The interactive gaming system includes a tabletop, where the tabletop is oriented horizontally and a stand, where the stand supports the tabletop. The interactive gaming system also includes a display screen integrated within the tabletop, where the display screen includes a touchscreen and a user interface shown on the display screen. The user interface allows a user to access a user account select a game and select game options. The game options include at least cooperative play or competitive play, number of players and game length. The user interface also allows a user to pay for the game.

Another example embodiment includes an interactive gaming system. The interactive gaming system includes a tabletop, where the tabletop is oriented horizontally and a stand, where the stand supports the tabletop. The interactive gaming system also includes a display screen integrated within the tabletop, where the display screen includes a touchscreen and a user interface shown on the display screen. The user interface allows a user to access a user account select a game and select game options. The game options include at least cooperative play or competitive play, number of players and game length. The user interface also allows a user to pay for the game. The interactive gaming system also includes a payment module, where the payment module is configured to allow a user to enter payment information.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of an interactive gaming table;

FIG. 2 illustrates an alternative example of the interactive gaming table;

FIG. 3 illustrates one example of a user interface;

FIG. 4 illustrates an alternative example of a user interface; and

FIG. 5 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

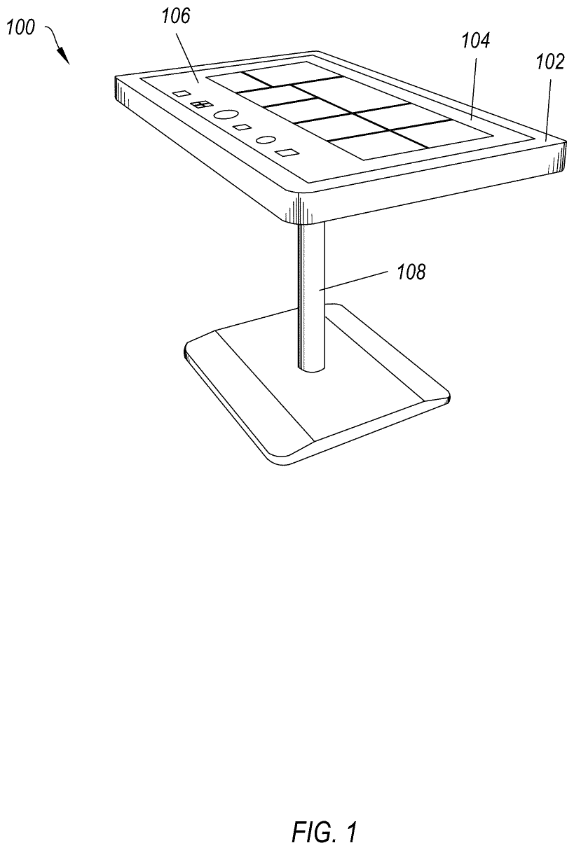

FIG. 1 illustrates an example of an interactive gaming table 100. The interactive gaming table 100 allows a user to play pay-for-play games at the user's choice. The games available may vary, but the interactive gaming table 100 allows the user to make necessary payments, pick among games, play against other players, etc. Thus, the interactive gaming table 100 is a mixture of hardware and software to provide the desired user experience.

FIG. 1 shows that the interactive gaming table 100 can include a tabletop 102. The tabletop 102 is a flat surface, where the user can place items. I.e., the tabletop 102 is substantially horizontal in orientation. One of skill in the art will appreciate that the tabletop 102 may be capable of tilting or rotating as needed by the user. In addition, one of skill in the art will appreciate that the tabletop 102 can be large enough to accommodate multiple players if needed. I.e., players can be allowed to play competitively (vs. one another or with remote games) or cooperatively with one another.

Figure also 1 shows that the interactive gaming table 100 can include a display screen 104. The display screen 104 takes up at least a portion of the table top 102. The display screen 104 can include any display device for presentation of images, text, or video transmitted electronically, without producing a permanent record. A display screen 104 can include one or more television sets, computer monitors, projectors, and/or digital signage. The display screen 104 can include only a display device or can include a touchscreen or other device (such as a holographic display or holographic elements).

A touchscreen, or touch screen, is a both input and output device and normally layered on the top of an electronic visual display of an information processing system. A user can give input or control the information processing system through simple or multi-touch gestures by touching the screen with a special stylus or one or more fingers. The user can use the touchscreen to react to what is displayed and, if the software allows, to control how it is displayed; for example, zooming to increase the text size. A touchscreen enables the user to interact directly with what is displayed, rather than using a mouse, touchpad, or other such devices (other than a stylus, which is optional for most modern touchscreens).

FIG. 1 further shows that the interactive gaming system 100 can include a user interface 106. The user interface 106 can allow the user to select options and/or play games. For example, the user interface can allow a user to select a game, select a payment method, play the game, etc. The user interface 106 can include a graphical user interface, controls, speakers, displays or any other necessary hardware and/or software to adequately display the desired information to one or more users.

In at least one implementation, a graphical user interface (“GUI” sometimes pronounced gooey) is a type of user interface 106 that allows users to interact with electronic devices with images rather than text commands. GUIs can be used in computers, hand-held devices such as MP3 players, portable media players or gaming devices, cell phones, household appliances and office equipment. A GUI represents the information and actions available to a user through graphical icons and visual indicators such as secondary notation, as opposed to text-based interfaces, typed command labels or text navigation. The actions are usually performed through direct manipulation of the graphical elements.

By way of example, the user interface 106 can include a computer program, app, webpage, website, or some other means for conveying desired gaming information to a user. For example, the user interface 106 can include a website that a user can log on to and enter payment information, select games, select other users to play with, etc. Additionally or alternatively, the user interface 106 can allow the user to change information within the interactive gaming system 106. For example, the user can select among saved payment information or user profiles.

FIG. 1 additionally shows that the interactive gaming table 100 can include a stand 108. The stand 108 supports the tabletop 102. The stand 108 holds the tabletop 102 in the desired position. For example, the stand 108 can be substantially vertical to hold the tabletop 102 in a horizontal position or can include horizontal portions.

The interactive gaming table 100 can include hardware that allows the interactive gaming table to perform the desired functions, as described below. In particular, the interactive gaming table 100 can include processors, memory, etc. to enable any desired functions. Likewise, the interactive gaming table 100 can include input devices, such as a keyboard (either physical or virtual) if so desired.

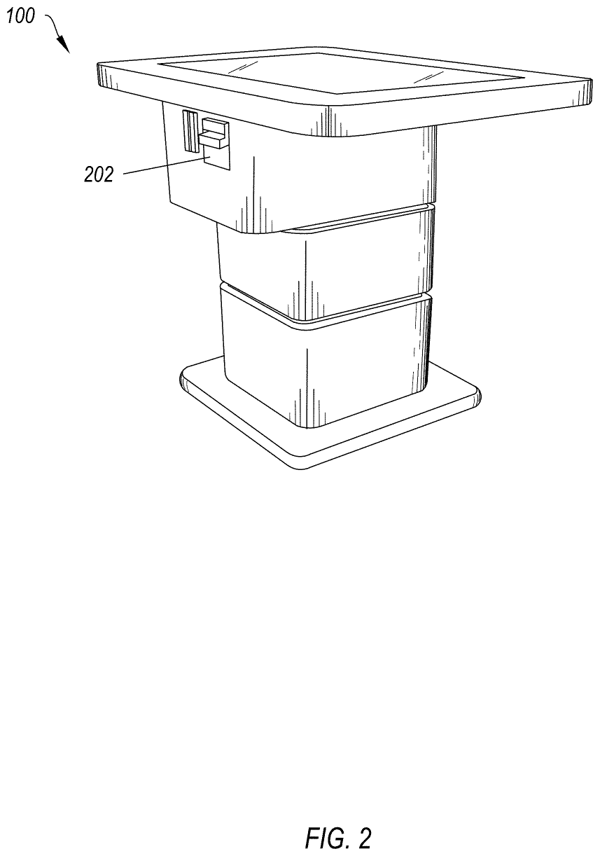

FIG. 2 illustrates an alternative example of the interactive gaming table 100. The interactive gaming table 100 includes a payment module 202. The payment module 202 allows a user to insert cash or use a credit card to play the games. That is, the payment module 202 allows a user to make payments to play games or make in-game purchase. For example, the payment module 202 can include a credit card reader that allows a user to pay with a credit or debit card.

The interactive gaming table 100 will include software that allows a user to play games, interact with other users, make payments, access an account, etc. I.e., the software will allow a user to perform desired functions on the interactive gaming table 100.

For example, the software may allow a user to access a menu which allows the user to pick from available games. Once a user chooses a game and other limits, such as optional rules for a game, number of players, time limits, etc., he/she will be presented with payment options. The payment can be made directly using the payment module 202 or can be made by accessing the user's account. Payment can be required of one user to pay for all players or can be required of each player individually or can give the user the option of selecting. One of skill in the art will appreciate that the interactive gaming table 100 can allow users to play a single game against one another or can allow individual users to play different games remotely against players not physically present or any desired combination thereof.

In addition, the games available on the interactive gaming table 100 can include games stored locally in memory or can connect remotely to games over a network. The network can include a proprietary network or can link to outside services, such as the Android Store or iOS App store or gaming services such as Steam.

Moreover, the interactive gaming table 100 can connect to an outside database which includes account information. For example, the interactive gaming table 100 can include internet connectivity which allows the user to login to a gaming service. The gaming service can include user information, payment information, rankings, game history, etc. Thus, the user can continue to play games even at different locations and at different interactive gaming tables 100.

Additionally, when a user purchases game time, he/she may be prompted with some form of payment processing options, such as by use of a stored payment method or by adding a payment module using the payment module 202. This could be directly with a credit card, or online through PayPal. These payments would go through the website backend and be associated with a specific table/time/game etc. The credits will follow the user to other locations/game tables. I.e., the user can access an account with payment credits, rewards, game history, etc. at any gaming table.

In addition, the software can provide backend integration and security. For example, the owner of the interactive gaming table 100 can choose and purchase apps or games (either in the form of bundles preloaded to the game table or with the ability to download desired from a central server).

Moreover, the interactive gaming table can require a connection to the internet to operate. This ensures that payment is properly received and the games are properly licensed. Failure to connect to a server that verifies correct licensing (either because of a loss of internet connection or some other problem) for a predetermined amount of time (e.g., one day, one week, etc.) will result in the machine being deactivated.

Likewise, an internet connection can allow for updates, diagnostics and service of the unit and to collect data regarding game and purchase trends. This can allow owners to determine the most profitable and/or popular ways to run the interactive gaming table.

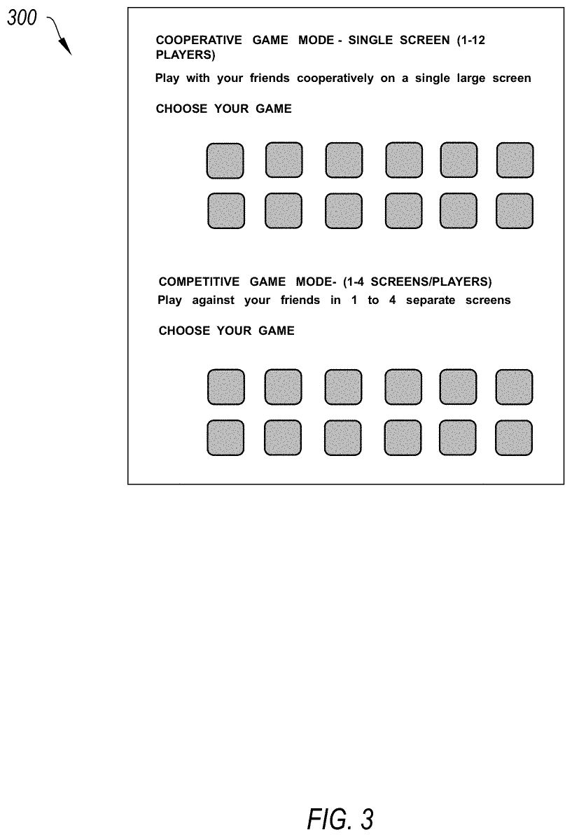

FIG. 3 illustrates one example of a user interface 300. The user interface 300 can vary by table capabilities. For example, smaller interactive gaming tables which are capable of hosting only a single player may have different menu options, and thus a different user interface 300, than a larger interactive gaming table which is capable of hosting multiple players.

FIG. 3 shows that the user interface can include an option for cooperative play vs. competitive play. I.e., whether the users play against one another (or other players remotely) or cooperatively. For example, the user interface can allow a user to select between:

1. Interactive games—cooperation mode (single screen—single or multiple players up to 12 players)
2. Split screen games—competition mode (screen will split into separate screens from 1 to 4 depending number of players chosen.

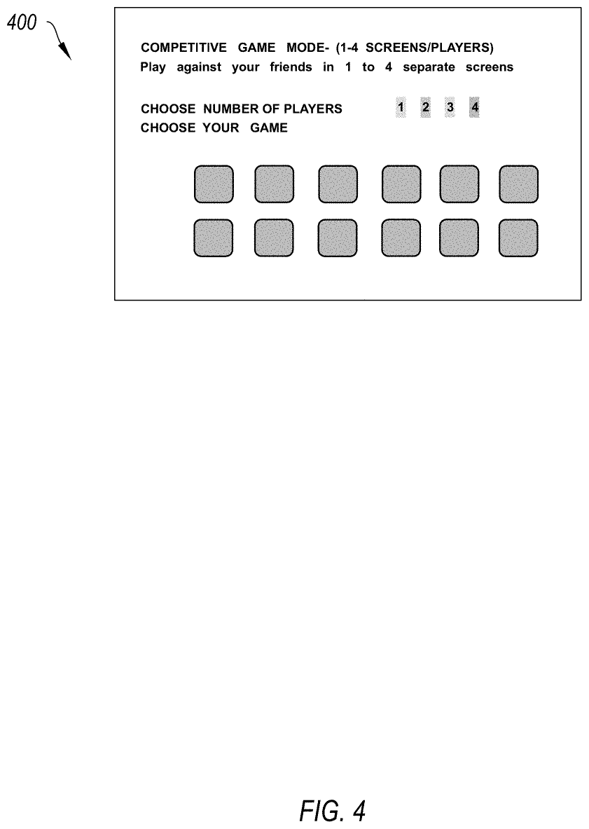

FIG. 4 illustrates an alternative example of a user interface 400. The user interface 400 can present a user with payment options. One of skill in the art will appreciate that the payment options can depend on the game mode and game selected. For example, after the game is selected the user interface 400 can prompt the user to link to an account or prepay for games based on time. E.g., the user may be able to select according to the following menu flow:
Upon choosing cooperation mode—interactive games boot up to full screen
   The user can select from among time periods and cost. For example:
      Cost per time block (e.g., $5 per every 15 minutes)
      The player can choose to play a full game for a set amount of money (e.g., $5 for a full game)
Follow up with a question that prompts the user with the previously selected option and asks the user to confirm the selection.
   If confirmed, the game starts
   If not confirmed, return to the payment options
Upon choosing competition mode—interactive games boot up to full screen
   The user selects the number of players
   The user can select from among time periods and cost. For example:
      Cost per time block per player (e.g., $5 for each player per every 15 minutes)
      The player can choose to play a full game for a set amount of money per player (e.g., $5 for each player for a full game)
Follow up with a question that prompts the user with the previously selected option and asks the user to confirm the selection.
   If confirmed, the game starts
   If not confirmed, return to the payment options
A pop up with a sound will appear on the screen indicating that 60 seconds are remaining, and giving the user a chance to add time
Upon end of time period game will end

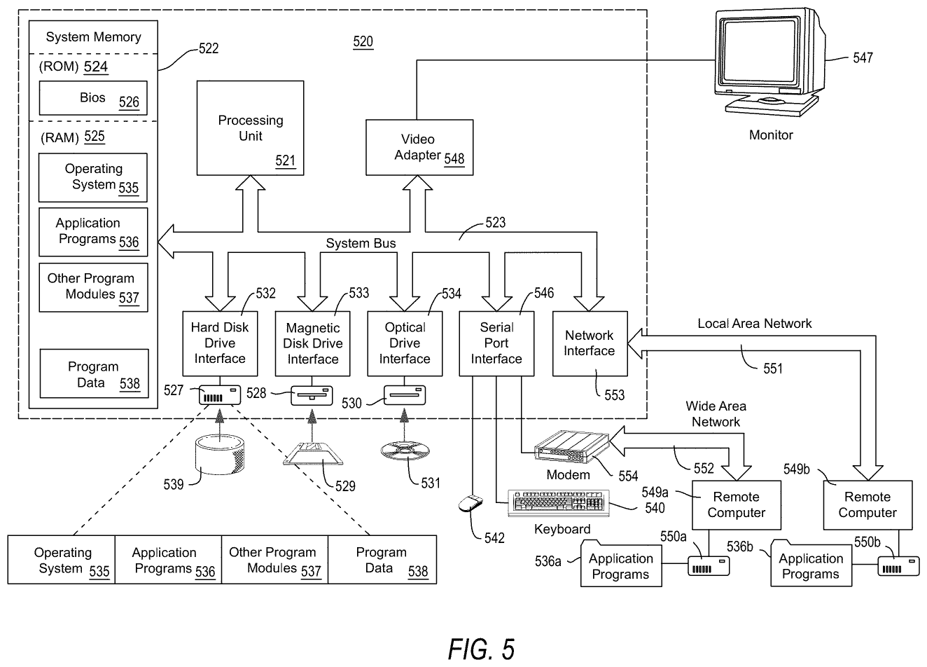

FIG. 5, and the following discussion, is intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One skilled in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 5, an example system for implementing the invention includes a general purpose computing device in the form of a conventional computer 520, including a processing unit 521, a system memory 522, and a system bus 523 that couples various system components including the system memory 522 to the processing unit 521. It should be noted however, that as mobile phones become more sophisticated, mobile phones are beginning to incorporate many of the components illustrated for conventional computer 520. Accordingly, with relatively minor adjustments, mostly with respect to input/output devices, the description of conventional computer 520 applies equally to mobile phones. The system bus 523 may be any of several types of bus structures including a memory bus or memory controller, a peripheral bus, and a local bus using any of a variety of bus architectures. The system memory includes read only memory (ROM) 524 and random access memory (RAM) 525. A basic input/output system (BIOS) 526, containing the basic routines that help transfer information between elements within the computer 520, such as during start-up, may be stored in ROM 524.

The computer 520 may also include a magnetic hard disk drive 527 for reading from and writing to a magnetic hard disk 539, a magnetic disk drive 528 for reading from or writing to a removable magnetic disk 529, and an optical disc drive 530 for reading from or writing to removable optical disc 531 such as a CD-ROM or other optical media. The magnetic hard disk drive 527, magnetic disk drive 528, and optical disc drive 530 are connected to the system bus 523 by a hard disk drive interface 532, a magnetic disk drive-interface 533, and an optical drive interface 534, respectively. The drives and their associated computer-readable media provide nonvolatile storage of computer-executable instructions, data structures, program modules and other data for the computer 520. Although the exemplary environment described herein employs a magnetic hard disk 539, a removable magnetic disk 529 and a removable optical disc 531, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 539, magnetic disk 529, optical disc 531, ROM 524 or RAM 525, including an operating system 535, one or more application programs 536, other program modules 537, and program data 538. A user may enter commands and information into the computer 520 through keyboard 540, pointing device 542, or other input devices (not shown), such as a microphone, joy stick, game pad, satellite dish, scanner, or the like. These and other input devices are often connected to the processing unit 521 through a serial port interface 546 coupled to system bus 523. Alternatively, the input devices may be connected by other interfaces, such as a parallel port, a game port or a universal serial bus (USB). A monitor 547 or another display device is also connected to system bus 523 via an interface, such as video adapter 548. In addition to the monitor, personal computers typically include other peripheral output devices (not shown), such as speakers and printers.

The computer 520 may operate in a networked environment using logical connections to one or more remote computers, such as remote computers 549a and 549b. Remote computers 549a and 549b may each be another personal computer, a server, a router, a network PC, a peer device or other common network node, and typically include many or all of the elements described above relative to the computer 520, although only memory storage devices 550a and 550b and their associated application programs 536a and 536b have been illustrated in FIG. 5. The logical connections depicted in FIG. 5 include a local area network (LAN) 551 and a wide area network (WAN) 552 that are presented here by way of example and not limitation. Such networking environments are commonplace in office-wide or enterprise-wide computer networks, intranets and the Internet.

When used in a LAN networking environment, the computer 520 can be connected to the local network 551 through a network interface or adapter 553. When used in a WAN networking environment, the computer 520 may include a modem 554, a wireless link, or other means for establishing communications over the wide area network 552, such as the Internet. The modem 554, which may be internal or external, is connected to the system bus 523 via the serial port interface 546. In a networked environment, program modules depicted relative to the computer 520, or portions thereof, may be stored in the remote memory storage device. It will be appreciated that the network connections shown are exemplary and other means of establishing communications over wide area network 552 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An interactive gaming system, the interactive gaming system comprising:
a tabletop;
a display screen integrated within the tabletop; and
a user interface shown on the display screen, wherein the user interface allows a user to:
select a game;
select one or more game options; and
pay for the game.

2. The interactive gaming system of claim 1, wherein the display screen includes a touchscreen.

3. The interactive gaming system of claim 1, wherein the tabletop is capable of tilting.

4. The interactive gaming system of claim 1, wherein the tabletop is oriented horizontally.

5. The interactive gaming system of claim 1, wherein the one or more game options includes the length of the game.

6. The interactive gaming system of claim 1, wherein the one or more game options includes the ability to pay for additional game time.

7. The interactive gaming system of claim 1, wherein the one or more game options includes the selection of optional rules.

8. The interactive gaming system of claim 1, wherein a failure to connect to a server for a specified amount of time will prevent the interactive gaming system from operating.

9. An interactive gaming system, the interactive gaming system comprising:
a tabletop, wherein the tabletop is oriented horizontally;
a stand, wherein the stand supports the tabletop;
a display screen integrated within the tabletop, wherein the display screen includes:
a touchscreen; and
a user interface shown on the display screen, wherein the user interface allows a user to:
access a user account;
select a game;
select game options, wherein the game options include at least:
cooperative play or competitive play;
number of players; and
game length; and
pay for the game.

10. The interactive gaming system of claim 9, wherein the display screen is divided into two or more regions, each of the two or more regions configured to display to a different user.

11. The interactive gaming system of claim 9, wherein the display screen is divided into four or more regions, each of the two or more regions configured to display to a different user.

12. The interactive gaming system of claim 9, wherein the game is played over a network.

13. The interactive gaming system of claim 12, wherein the network includes the internet.

14. The interactive gaming system of claim 9, wherein the game is stored locally.

15. An interactive gaming system, the interactive gaming system comprising:
a tabletop, wherein the tabletop is oriented horizontally;
a stand, wherein the stand supports the tabletop;
a display screen integrated within the tabletop, wherein the display screen includes:
a touchscreen;
a user interface shown on the display screen, wherein the user interface allows a user to:
access a user account;
select a game;
select game options, wherein the game options include at least:
cooperative play or competitive play;
number of players; and
game length; and
pay for the game; and
a payment module, wherein the payment module is configured to allow a user to enter payment information.

16. The system of claim 15, wherein accessing the user account includes accessing the user's stored payment information.

17. The system of claim 15, wherein accessing the user account includes accessing the user's friend information.

18. The interactive gaming system of claim 15, wherein accessing the user account includes accessing the user's game history.

19. The interactive gaming system of claim 15, wherein the payment module includes a credit card reader.
